(19) United States
(12) Patent Application Publication
(10) Pub. No.: US 2012/0002508 A1
(43) Pub. Date: Jan. 5, 2012

(54) UNDERWATER ANTENNA

(75) Inventors: Andreas Kristann, Bremen (DE); Jürgen Lindner, Ganderkesse (DE); Wilfried Junge, Bremen (DE)

(73) Assignee: Atlas Elektronik GmbH, Bremen (DE)

(21) Appl. No.: 13/124,344

(22) PCT Filed: Oct. 16, 2009
(86) PCT No.: PCT/EP2009/063581

§ 371 Date: May 10, 2011

(30) Foreign Application Priority Data
Oct. 20, 2008 (DE) 10 2008 052 354.2

(51) Int. Cl. G10K 11/00

(52) U.S. Cl. 367/153

(57) ABSTRACT

A submarine antenna, in particular for assembly on the hull of a submarine, comprising a number of adjacently arranged electroacoustic converters each with a number of hydrophones arranged one below the other and a reflector arranged behind the converters in the direction of incidence of the sound. According to the invention, hull noise decoupling of the converter can be achieved at the connection to the reflector wherein the hydrophones arranged one beneath the other of each converter are moulded into a converter bar by an acoustically transparent moulded mass and the converter bars are provided with sprung retainer elements at the bar ends which are held by retainer devices made on the reflector.

The invention relates to an underwater antenna, in particular for fitting to the hull of a submarine, according to the precharacterizing clause of claim 1.

A known underwater antenna (DE 43 39 798 A1), which is in the form of a cylindrical base, has a plurality of antenna elements in the form of staves which are mounted on an antenna mount, in this case on the outer wall of a hollow cylinder, at equal intervals. Each antenna element in the form of a stave has a reflector, which comprises a metal plate and a soft material panel, and a plurality of hydrophones which are arranged one above the other and are arranged in front of the reflector in the sound incidence direction. In this case, each hydrophone is adhesively bonded to a spacer composed of polyurethane, which is mounted, for example adhesively bonded, on the metal plate. All the hydrophones are routed via connecting lines on a common plug. The reflector and the hydrophones with the connecting lines are embedded in an acoustically transparent encapsulation compound composed of an essentially viscoplastic elastomer, for example polyurethane, which can be processed using the casting process. Aperture holes are provided in the encapsulation compound, through which screws are passed, in order to attach the antenna element in the form of a stave to the antenna mount. The hydrophones are small spherical ceramics, and the metal plate is formed from two metal sheets with an elastic layer between them, for bending wave damping.

One known, flat underwater antenna, also referred to as a flat antenna (DE 10 2004 037 987 A1), is composed of a plurality of panel-like antenna segments. Each antenna segment has an acoustically transparent plastic plate-like body, in which hydrophones arranged in rows and columns, and an inflexible plate, which is used as a reflector and is arranged behind the hydrophones in the sound incidence direction, are embedded. A flat antenna such as this which is designed for receiving antennas in the medium to relatively high frequency range has a good back-to-front ratio and also provides good beam formation for the directivity in the vertical reception range, and therefore an improved signal-to-noise ratio, because of the capability to additively combine the output signals from the hydrophones which are arranged vertically one above the other in columns when the antenna is in the installed position.

The invention is based on the object of acoustically decoupling the electroacoustic transducers from the structure-borne sound originating from an antenna mount, for an underwater antenna which extends over an area.

According to the invention, the object is achieved by the features of claim 1.

The underwater antenna according to the invention has the advantage that the surrounding encapsulation of the hydrophones which are located one above the other with an acoustically transparent encapsulation compound results in a transducer in the form of a stave with an improved signal-to-noise ratio because of the beam formation of its directivity in the vertical reception range which, by means of the spring elements at the ends, forms a spring and mass system whose resonant frequency can be tuned by appropriate dimensions of the spring elements such that it is well away from the useful frequency range of the underwater antenna. The transducers in the form of staves in the underwater antenna are therefore acoustically decoupled at the connection to the reflector in the hydroacoustically important useful frequency range from the interfering structure-borne sound transmitted from the hull to the reflector, thus improving the overall signal-to-noise ratio of the underwater antenna.

Expedient embodiments of the underwater antenna according to the invention together with advantageous developments and refinements of the invention are specified in the further claims.

According to one advantageous embodiment of the invention, the sprung holding elements are formed integrally with the encapsulation compound. This allows the sprung holding elements to be produced with their dimensions that govern the frequency in one process with the manufacture of the transducer staves.

According to one advantageous embodiment of the invention, the sprung holding elements have a T-shaped cross section with a resilient center web and a lateral part which is preferably in the form of a plate. The center webs of the holding elements are formed in a simple manner by constriction of the encapsulation compound which surrounds the hydrophones. The lateral parts of the holding elements are suspended in an upper and a lower holding apparatus, which are each fixed to the reflector. This allows the transducer staves to be fitted quickly and easily, since the lateral parts of the transducer staves can simply be suspended in the upper holding apparatus, and need not be held by the fitter while being mounted in the lower holding apparatus.

According to one advantageous embodiment of the invention, the lateral parts of the holding elements are held in an interlocking manner in cutouts which are provided in the holding apparatuses, wherein one lateral part, preferably the lateral part of the upper holding elements, has an asymmetric shape on one transducer stave. This asymmetry of the lateral parts on one of the holding elements on the transducer staves ensures that each transducer stave is installed in the same position.

According to one advantageous embodiment of the invention, the reflector is provided with hard surrounding encapsulation, and the upper holding apparatus is formed integrally with the hard surrounding encapsulation, in the form of a strip which extends transversely with respect to the transducer staves, with the cutouts for holding the lateral parts of the upper holding elements of the transducer staves being formed at equal intervals in the strip. The lower holding apparatus has a plurality of holders which hold the lower holding elements of the transducer staves in pairs and are firmly screwed to the reflector. The upper holding elements of the transducer staves are suspended in the cutouts in the strip, and their lower holding elements are fixed in pairs by a holder of the lower holding apparatus on the reflector, in such a way that the transducer staves cannot be detached from the reflector in any position of the reflector.

The invention will be described in more detail in the following text with reference to one exemplary embodiment, which is illustrated in the drawing, in which:

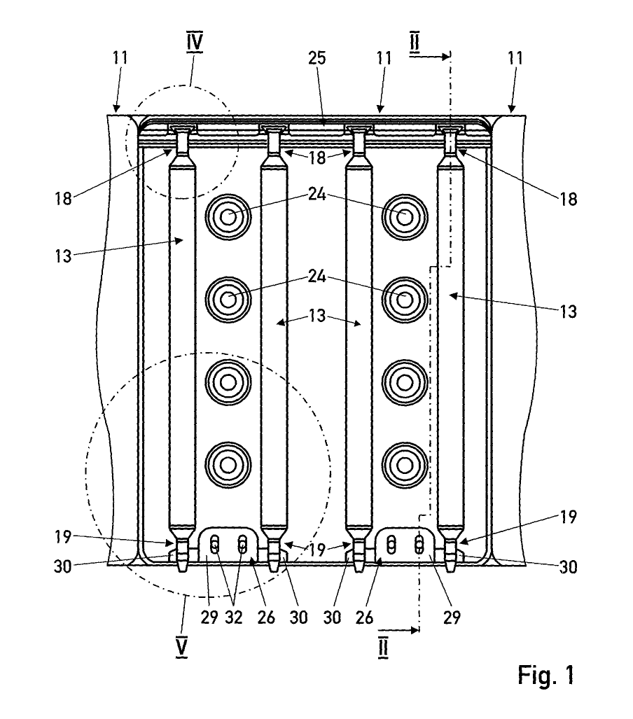

FIG. 1 shows a detail of a plan view of an underwater antenna,

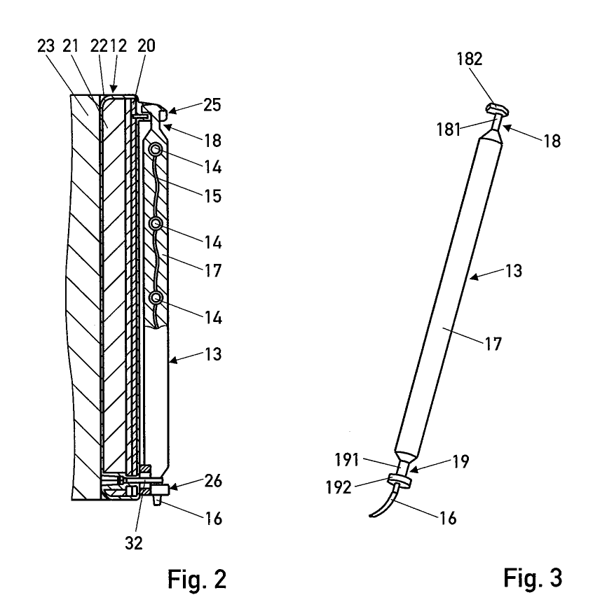

FIG. 2 shows a section along the line II-II in FIG. 1,

FIG. 3 shows a perspective illustration of a transducer stave of the underwater antenna in FIGS. 1 and 2,

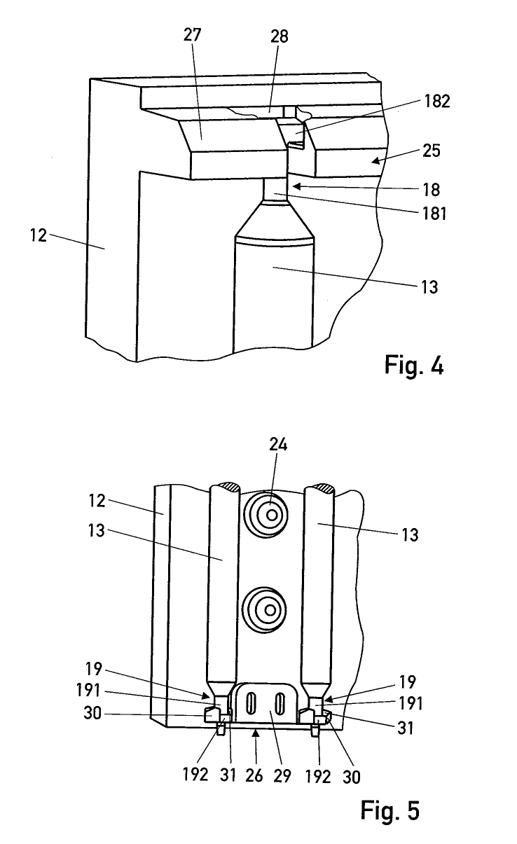

FIG. 4 shows an enlarged perspective illustration of the detail IV in FIG. 1,

FIG. 5 shows an enlarged perspective illustration of the detail V in FIG. 1.

The underwater antenna, a detail of which is illustrated in the form of a plan view in FIG. 1, is preferably designed as a flat flank antenna for fitting to the hull of a submarine. There is normally one flank antenna in each case, on both the port and starboard sides. The underwater antenna is composed of a plurality of antenna segments 11 which are fitted adjacent to one another horizontally along the hull. The number of antenna segments 11 fitted adjacent to one another varies depending on the length of the underwater antenna and of the hull.

Each antenna segment 11, of which FIG. 1 illustrates only one antenna element 11 in detail, has a reflector 12 and a plurality of electroacoustic transducers, which are arranged at equal intervals alongside one another, referred to in the following text as transducer staves 13, which are arranged in front of the reflector 12 in the sound incidence direction. Each transducer stave 13 has a plurality of hydrophones 14, which are arranged at equal intervals one above the other, in the form of small spherical ceramics, as can be seen from the section illustration in FIG. 2. Electrical connecting lines 15 are routed to the hydrophones 14 and are combined at the lower end of the transducer stave 13 to form a cable 16 (FIG. 3), which emerges from the transducer stave 13. The hydrophones 14, which are arranged one above the other, are embedded in an acoustically transparent encapsulation compound 17, for example polyurethane, with the encapsulation compound 17 predetermining the circular or rectangular stave shape of the transducer staves 13. A sprung upper holding element 18 and a sprung lower holding element 19 are formed by means of the encapsulation compound 17 at each end of the transducer stave 13. The holding elements 18, 19 have a T-shaped cross section with a respective center web 181 and 191, and a respective lateral part 182 and 192 in the form of a plate. The center webs 181 and 191 are formed in a simple manner by constriction of the encapsulation compound 17, in which case the constriction of the encapsulation compound 17 in the area of the lower center web 191 is limited by the cable 16 which runs there for the hydrophones 14. While the lateral part 192, which is in the form of a plate, of the lower holding element 19 is designed to be rotationally symmetrical, the lateral part 182, which is in the form of a plate, of the upper holding element 18 is shaped asymmetrically.

The reflector 12, which is shown in the form of a plan view in FIG. 1 and in the form of a section in FIG. 2, has a metal plate 20 which is composed of two thin metal sheets and is placed on a soft material panel 21, for example composed of polyurethane foam. The metal plate 20 and the soft material panel are encapsulated jointly by means of surrounding encapsulation 22 composed of water-resistant plastic, for example of polyurethane. The reflector 12 is attached to an antenna mount 23, which is sketched in the form of a detail in FIG. 2. The screw heads 24 of the screws which are screwed into the antenna mount 23 for this purpose can be seen in FIG. 1. By way of example, the antenna mount 23 may be a buoyant body composed of a hard foam core with hard surrounding encapsulation, which is itself fixed to the hull. The sprung holding elements 18, 19 of the transducer staves 13, which are arranged in front of the reflector 12 in the sound incidence direction, are fixed to the reflector 12 by means of an upper holding apparatus 25 and a lower holding apparatus 26, with the lateral parts 182, 192, which are in the form of plates, being held in the respective holding apparatuses 25, 26. The upper holding apparatus 25 is in the form of a strip 27 which extends along the upper lateral edge of the reflector 12 and is also encapsulated at the same time in the surrounding encapsulation 22 during the production of the reflector 12. As can be seen particularly clearly from FIG. 4, cutouts 28 are arranged at equal intervals in the strip 27 and are shaped such that the asymmetric lateral parts 182, which are in the form of plates, of the upper holding elements 18 of the transducer staves 13 are held in an interlocking manner in the cutouts 28. This ensures that all the transducer staves are fitted with the same alignment. The lower holding apparatus 26 consists of individual holders 29, which fix the transducer staves 13 in pairs to the reflector 12. Each holder 29 has two side lugs 30. A cutout 31 is provided in each lug 30, in order to hold a rotationally symmetrical lateral part 192 of a lower holding element 19 of a transducer stave 13 in an interlocking manner. The holders 29 are screwed firmly to the reflector 12 by means of attachment screws 32 (FIGS. 1 and 2).

1. An underwater antenna, in particular for fitting to the hull of a submarine, having a plurality of electroacoustic transducers which are arranged alongside one another and each have a plurality of hydrophones arranged one above the other, and having a reflector which is arranged behind the transducers in the sound incidence direction, wherein the hydrophones which are arranged one above the other in each transducer are encapsulated by an acoustically transparent encapsulation compound to form a transducer stave, and each transducer stave is provided at its stave ends with sprung holding elements which are fixed to the reflector.

2. The underwater antenna as claimed in claim 1, wherein the sprung holding elements are formed from the encapsulation compound.

3. The underwater antenna as claimed in claim 2, wherein the sprung holding elements have a T-shaped cross section with a resilient center web and a lateral part which is preferably in the form of a plate.

4. The underwater antenna as claimed in claim 3, wherein the center webs of the holding elements are formed by major constrictions in the encapsulation compound.

5. The underwater antenna as claimed in claim 3, wherein one of the lateral parts of the holding elements of one transducer stave is in each case suspended in an upper, and one in a lower, holding apparatus, which are each fixed to the reflector.

6. The underwater antenna as claimed in claim 5, wherein one of the two lateral parts, preferably the lateral part of the upper holding element, has an asymmetric shape.

7. The underwater antenna as claimed in claim 5, wherein the lateral parts are held in an interlocking manner in cutouts which are provided in the holding apparatuses.

8. The underwater antenna as claimed in claim 7, wherein the reflector is provided with a surrounding encapsulation, and the upper holding apparatus is formed integrally with the surrounding encapsulation, in the form of a strip which extends transversely with respect to the transducer staves, and the cutouts for the lateral parts of the upper holding elements on the transducer staves are formed at equal intervals in the strip.

9. The underwater antenna as claimed in claim 7, wherein the lower holding apparatus has a plurality of holders which hold the lower holding elements of the transducer staves in pairs and are attached to the reflector, and the holders have lugs which project at the side, in each of which a cutout is formed for the lateral part of the lower holding element on a transducer stave.

10. The underwater antenna as claimed in claim 1, wherein the reflector is attached to an antenna mount.
